(19) United States
(12) Patent Application Publication
(10) Pub. No.: US 2025/0141521 A1
(43) Pub. Date: May 1, 2025

(54) WIRELESS TELECOMMUNICATIONS NETWORK

(71) Applicant: BRITISH TELECOMMUNICATIONS PUBLIC LIMITED COMPANY, LONDON (GB)

(72) Inventors: Anvar TUKMANOV, London (GB); Arman SHOJAEIFARD, London (GB)

(21) Appl. No.: 18/681,915

(22) PCT Filed: Jul. 13, 2022
(86) PCT No.: PCT/EP2022/069684

§ 371 Date: Feb. 7, 2024

(30) Foreign Application Priority Data
Aug. 12, 2021 (GB) 2111567.0

(51) Int. Cl. H04B 7/06; H04B 7/0452

(52) U.S. Cl. CPC H04B 7/063; H04B 7/0452; H04B 7/0632

(57) ABSTRACT

This disclosure provides a method of operating a transmitting node in a wireless telecommunications network, wherein the transmitting node is configured to transmit data to a first receiving node, the method including determining that a first spatial path count for transmissions between the transmitting node and first receiving node satisfies a first Signal to Interference plus Noise Ratio (SINR) threshold and a first capacity threshold; and causing the transmitting node to use the determined first spatial path count in transmissions to the first receiving node.

### PRIORITY CLAIM

The present application is a National Phase entry of PCT Application No. PCT/EP2022/069684, filed Jul. 13, 2022, which claims priority from GB Application No. 2111567.0, filed Aug. 12, 2021, each of which hereby fully incorporated herein by reference.

### TECHNICAL FIELD

The present disclosure relates to a wireless telecommunications network.

### BACKGROUND

Multiple-Input Multiple-Output (MIMO) technology involves a transmitter and receiver having multiple antennas so that wireless signals can be transmitted between the transmitter and receiver over a plurality of paths using the same spectral resources. This has been exploited by use of spatial multiplexing, in which a plurality of data streams to be transmitted to the receiver are transmitted simultaneously on distinct paths of the plurality of paths between the transmitter and receiver. Each path of the plurality of paths is often known as a “layer”.

Existing MIMO deployments in the 4^{th} Generation (4G) Long Term Evolution (LTE) network, as standardized by the 3^{rd} Generation Partnership Project (3GPP), include Single-User MIMO (SU-MIMO) in which multiple data streams are transmitted simultaneously between the base station and a single UE using a plurality of layers, increasing the peak throughput between the base station and UE. Another example of MIMO is Multi-User MIMO (MU-MIMO) in which the base station transmits multiple data streams to a plurality of UE, in which each data stream is for a particular UE and uses a particular layer. This increases the aggregate throughput (i.e. capacity). The number of base station antennas must be at least equal to the number of UE in MU-MIMO. Another example of MIMO is massive MIMO (mMIMO) in which the number of base station antennas is significantly greater than the number of UE, and the base station can select between SU-MIMO and MU-MIMO operation modes. This allows multiple data streams to be transmitted simultaneously between the base station and each UE using a plurality of layers. In practice, mMIMO systems typically include 32 or 64 base station antennas.

A base station may employ an Active Antenna System (AAS) to realize such antenna counts. Conventionally, AAS schedulers aim to maximize the aggregate throughput of a mMIMO system.

### SUMMARY

According to a first aspect of the disclosure, there is provided a method of operating a transmitting node in a wireless telecommunications network, wherein the transmitting node is configured to transmit data to a first receiving node, the method comprising determining that a first spatial path count for transmissions between the transmitting node and first receiving node satisfies a first Signal to Interference plus Noise Ratio, SINR, threshold and a first capacity threshold; and causing the transmitting node to use the determined first spatial path count in transmissions to the first receiving node.

The first spatial path count may be determined by iteratively evaluating a plurality of candidate first spatial path counts or as a solution to a multi-objective optimization problem.

The transmitting node may be caused to use the determined first spatial path count by adjusting a precoder of the transmitting node or by adjusting a count of active transceiver chains.

The wireless telecommunications network may include a second receiving node, and the method further comprises determining that a second spatial path count for transmissions between the transmitting node and second receiving node satisfies a second SINR threshold and a second capacity threshold; and causing the transmitting node to use the determined second spatial path count in transmissions to the second receiving node.

According to a second aspect of the disclosure, there is provided a computer program comprising instructions which, when the program is executed by a computer, cause the computer to carry out the first aspect of the disclosure. The computer program may be stored on a computer readable carrier medium.

According to a third aspect of the disclosure, there is provided a network node for a wireless telecommunications network, the wireless telecommunications network including a transmitting node and a first receiving node, the network node comprising a processor configured to determine that a first spatial path count for transmissions between the transmitting node and first receiving node satisfies a first Signal to Interference plus Noise Ratio, SINR, threshold and a first capacity threshold; and to cause a transmitter of the transmitting node to use the determined first spatial path count in transmissions to the first receiving node. The network node may be the transmitting node.

### BRIEF DESCRIPTION OF THE FIGURES

In order that the present disclosure may be better understood, embodiments thereof will now be described, by way of example only, with reference to the accompanying drawings in which:

FIG. 1 is a graph illustrating the Signal to Interference plus Noise Ratio (SINR) per layer and aggregate throughput against layer count.

FIG. 2 is a schematic diagram illustrating a wireless telecommunications network of a first embodiment of the present disclosure.

FIG. 3 is a schematic diagram of a base station of the network of FIG. 2.

FIG. 4 is a schematic diagram of a User Equipment (UE) of the network of FIG. 2.

FIG. 5 is a flow diagram illustrating a method of a first embodiment of the present disclosure.

### DETAILED DESCRIPTION OF EMBODIMENTS

In the following description, the terms “layer” and “spatial path” are used interchangeably. The skilled person will understand that these terms may both be used to describe a medium for transmission of a data stream between a transmitter and receiver, being one of a plurality of data streams that may be transmitted concurrently between the transmitter and receiver using a plurality of such media. These layers/spatial paths are typically created by the antenna systems at the transmitter and receiver, the channel and via digital signaling processing techniques.

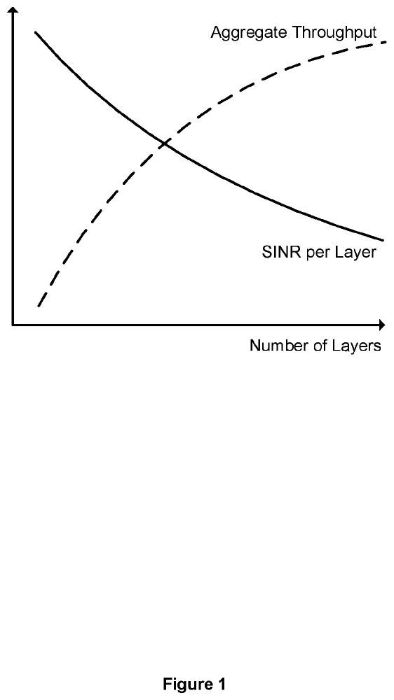

It can be shown that the aggregate throughput of a MIMO system is increased as the number of layers used between a transmitter and each receiver is increased. However, there are trade-offs affecting performance of a MIMO system as the number of layers is increased. Generally, as the number of layers is increased, there is a smaller share of signal power available to each layer and more interference between layers. This is represented by a decrease in a Signal to Interference plus Noise Ratio (SINR) per layer. This trade-off is represented graphically in FIG. 1 (in which the SINR per layer is represented by the solid line and the aggregate capacity is represented by the dashed line).

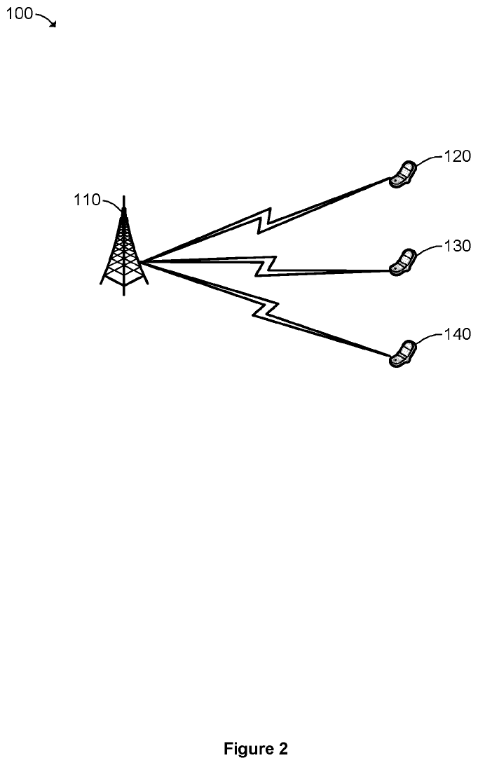

A first embodiment of a wireless telecommunications network will now be described with reference to FIGS. 2 to 4. In this first embodiment, the wireless telecommunications network is a cellular telecommunications network 100 having a first base station 110, a first User Equipment (UE) 120, a second UE 130 and a third UE 140. The first base station 110, and first UE 120 are both multi-antenna transceivers whilst the second and third UE 130, 140 are single-antenna transceivers. The cellular telecommunications network 100 represents a Multiple-User Multiple-Input Multiple-Output (MU-MIMO) system in which the base station 110 simultaneously transmits a plurality of data streams in which each data stream uses a distinct spatial path. The base station 110 may use one or more distinct spatial paths with each of the first, second and third UE 120, 130, 140.

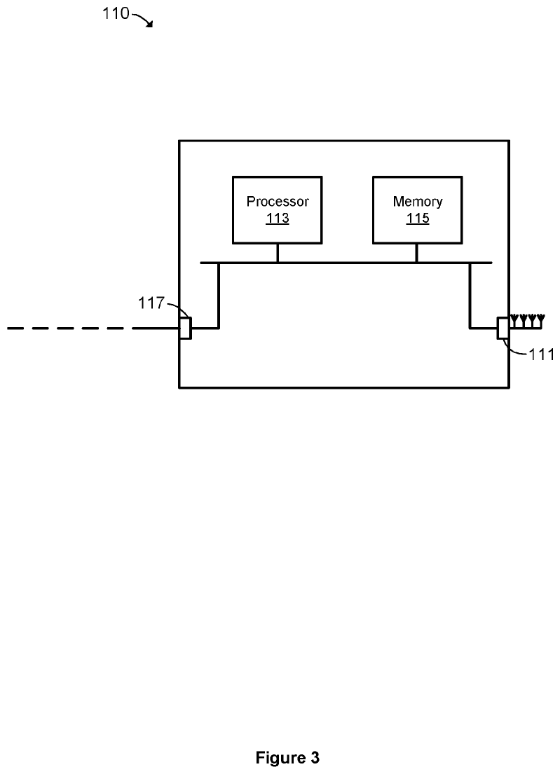

FIG. 3 illustrates the base station 110 in more detail. The base station 110 includes a first communications interface 111 configured for wireless communications with the first, second and third UE 120, 130, 140, a processor 113, memory 115, and a second communications interface 117. The first communications interface 111 is connected to a plurality of antennas, which in this example includes four antennas. The second communications interface 117 is configured to communicate with a core network, and in this embodiment receives data for transmission to one or more of the first, second and third UE 120, 130, 140. The processor and memory modules of the transmitter are configured to process and store (i.e. buffer) these data streams for transmission to the respective UE via one or more wireless telecommunications protocols. The processor 113 is configured to determine a count of layers to use in communications to each UE by implementing an embodiment of a method of the present disclosure, discussed below. Furthermore, the processor 113 includes a precoder module and a scheduler module. The count of layers determined by the processor may be implemented by the precoder by adjusting a signal processing algorithm based on the count of layers (examples of such algorithms can be found in 3GPP air interface standards, such as Technical Specification 36.211, Section 6) or by adjusting the number of antennas used by the base station 110.

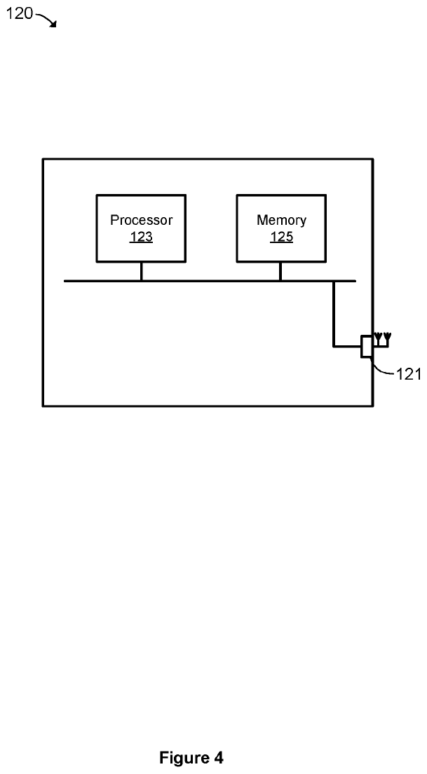

FIG. 4 illustrates the first UE 120 in more detail. The first UE 120 includes a first communications interface 121 configured for wireless communications with the base station 110 and, in this embodiment, includes two antennas. The first UE 120 also includes a processing module 123 and memory module 125 to enable the first UE 120 to participate in communications with the base station 110 using one or more wireless communications protocols. The second and third UE 130, 140 are very similar to the first UE 120, but their respective first communications interfaces only include a single antenna.

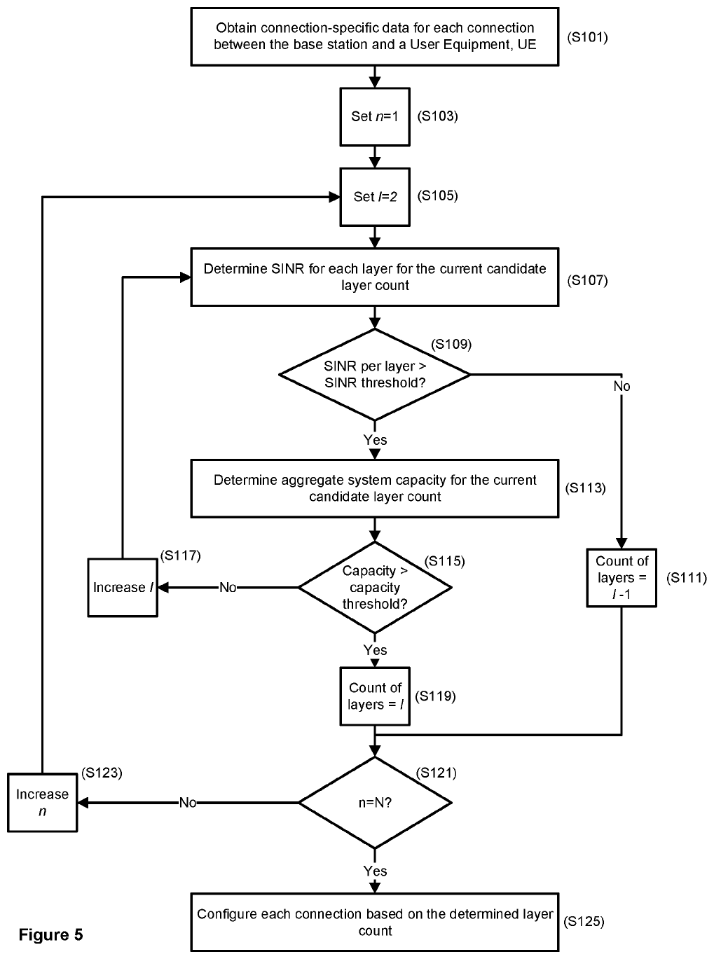

A first embodiment of a method of the present disclosure will now be described with reference to FIG. 5. In this first embodiment, the base station 110 has a first connection with the first UE 120, a second connection with the second UE 130, and a third connection with the third UE 130. In S101, the base station 110 obtains data identifying connection specific data for the first connection, connection specific data for the second connection, and connection specific data for the third connection.

The base station 100 then enters an iterative loop to determine a first count of layers to use for a transmission of the first connection, a second count of layers to use for a transmission of the second connection, and a third count of layers to use for a transmission of the third connection. The count of layers for each connection is determined by iteratively analyzing candidate layer counts for each connection until a termination condition is met. In the following description, a candidate layer count is identified by letter l of a set 2 to L, and the connection is identified by letter n of a set 1 to N. In a first iteration, the base station 110 analyses candidate layer counts for the first connection (such that n is set to 1 in S103) and the initial candidate layer count to be analyzed is 2 layers (such that l is set to 2 in S105). In S107, the base station 110 determines the SINR for each layer in the candidate layer count. The SINR may be determined based on the connection specific data for the first connection received in S101. For example, if the connection specific data for the first connection indicates that the first connection requires data transmission using a particular Modulation and Coding Scheme (MCS), then a lookup operation may be performed with the stored SINR values to determine the overall SINR required for that MCS. This overall SINR may then be divided by the candidate layer count (2, in this first iteration) to determine the SINR per layer.

Other methods for determining the SINR for each layer include:
1) Transmitting reference signals having a known symbol and known power to a receiver. These reference signals are measured at the receiver to determine the noise and interference;
2) Using “zero power” reference signals in which the transmitter does not transmit during a known time period. The receiver may then measure the channel during this period to determine the noise and interference; and
3) Indirect estimation by measuring the errors in a data transmission. This may be correlated (based on the MCS being used) to a SINR value.

In S109, it is determined whether the SINR per layer for the current candidate layer count satisfies an SINR threshold. This SINR threshold may be a common SINR threshold that applies to each layer of the current candidate layer count, or there may be an SINR threshold for each layer. The SINR threshold may be based on a service constraint specifying the minimum SINR that must be achieved between the base station 110 and first UE 120. The SINR threshold may also be based on transmission queue buffers at the base station 110 for the first UE 120. For example, if the buffers reach a threshold level indicating that they are nearly full, the base station 110 may set a relatively high SINR threshold in order to empty the buffer as quickly as possible. In another example, if the buffers drop below a threshold level indicating that they are nearly empty (or there is tolerance to transmission delay), the base station 110 may set a relatively low SINR threshold. If the SINR per layer does not satisfy this SINR threshold, then it is determined (in S111) that the count of layers for this first connection should be l−1 and the method skips to S121 (described below). In this first iteration in which the candidate layer count is 2, then if this candidate layer count does not satisfy the SINR threshold then the count of layers for the first connection would be 1. If the SINR per layer does satisfy this SINR threshold, then the method proceeds to S113.

In S113, the base station 100 calculates an aggregate system capacity for the current candidate layer count. This may be determined based on the Shannon-Hartley theorem as:

$${\sum }_{i = 1}^{L} {C}_{l} = {\sum }_{i = 1}^{L} B {log}_{2} ( 1 + {SINR}_{i} )$$

In which Bis the bandwidth of the channel and SINRᵢ is the SINR for layer i (in which i is a set of 1 to L) as calculated in S107.

In S115, it is determined whether the calculated aggregate system capacity for the current candidate layer count satisfies a capacity threshold. This capacity threshold may be based on the capacity required to satisfy user demand, or may also be based on a service constraint specifying the minimum capacity for the connection between the base station 110 and first UE 120. If the calculated aggregate system capacity satisfies the capacity threshold, then it is determined (in S119) that the count of layers for this connection should be l and the method proceeds to S121. If the calculated aggregate system capacity for the current candidate layer count does not satisfy the capacity threshold, then the method loops back to S107 for a further iteration by increasing, in S117, the candidate layer count. In this example, the candidate layer count is increased by 1 for the next iteration. The above process therefore iterates through S107 to S117 until either a first termination condition is met (that is, the SINR per layer does not satisfy the SINR threshold such that the first layer count is set at l−1) or a second termination condition is met (that is, the calculated aggregate system capacity satisfies the capacity threshold such that the first layer count is set at l).

In S121, the base station 100 determines whether one or more layer counts need to be calculated for other connections. In this example in which the base station 100 has determined the first layer count for the first connection, but has not yet determined the second layer count for the second connection or the third layer count for the third connection, then the process loops back to S105 so as to determine the layer count for the next connection (by increasing, in S123, the connection identifier by 1). The base station 100 therefore determines, by the same process, the layer count for each connection until the termination condition of S121 is met (i.e. when n=N). The SINR and capacity thresholds may be the same or different for each connection. Once the termination condition has been met, the method proceeds to S125.

In S125, the base station 100 configures the first connection to use the first layer count, configures the second connection to use the second layer count, and configures the third connection to use the third layer count. This may be achieved by adjusting the precoder (that is, by adjusting a signal processing algorithm based on the layer count) or the antenna array (that is, by adjusting the number of active transceiver chains based on the layer count). The base station 100 then communicates with each UE using these configured connections.

The above embodiment therefore strikes a balance between the performance trade-offs between increased capacity and SINR per layer. That is, the capacity of each connection between the base station and a UE is maximized given a constraint of maintaining SINR per layer below a threshold. By maintaining SINR per layer below a threshold, there are certain performance benefits, such as lower signaling overhead and fewer channel feedback operations.

The layer count for each connection is used for a time period which may be based on the connection quality (for example, the block error rate relative to a threshold), the channel coherence time, and/or the termination of the data transmission session. Thus, the above process may be triggered periodically following expiry of this time period.

In the above embodiment, the layer count for each connection was determined by evaluating candidate layer counts in an iterative manner until a termination condition was met. However, the skilled person will understand that a more direct calculation of the layer count for each connection may be performed by solving a multi-objective optimization problem. For example, the layer count calculation may be formulated as a weighted sum which maximizes a positively weighted convex sum of objectives, γ(L), C(L), that is:

$$\begin{matrix}{max}_{L , {w}_{γ} , {w}_{C}} {w}_{γ} γ ( L ) + {w}_{C} C ( L ) \\ subject to : γ ( L ) \geq {γ}_{0} \\ C ( L ) \geq {C}_{0} \\ {w}_{γ} + {w}_{C} = 1\end{matrix}$$

In which γ₀ is the SINR per layer threshold, C₀ is the capacity threshold, w_{γ} is a weight factor for the SINR per layer and w_{c} is a weight factor for the capacity. Such problems may be solved, for example, by gradient-based algorithms and sub-optimal heuristics.

The above first embodiment is performed by a processor of the base station 110. The skilled person will understand that any transmitting node that may transmit to a receiving node via a plurality of spatial layers may implement the method of the present disclosure (including in other forms of wireless telecommunications network, such as a wireless wide area network or wireless local area network). Furthermore, the skilled person will understand that the determination of the count of spatial layers may be determined by a processing node that is remote from the transmitter, such that the processing node sends an instruction message to the transmitter to use the determined spatial layer count.

The skilled person will understand that the method of the above embodiment may be applied to a scenario in which the transmitter is in communication with a single receiving node. Furthermore, it is non-essential that the receiving node includes multiple antennas.

The skilled person will understand that any combination of features is possible within the scope of the disclosure, as claimed.

1. A method of operating a transmitting node in a wireless telecommunications network, wherein the transmitting node is configured to transmit data to a first receiving node, the method comprising:
determining that a first spatial path count for transmissions between the transmitting node and first receiving node satisfies a first Signal to Interference plus Noise Ratio (SINR) threshold and a first capacity threshold; and
causing the transmitting node to use the determined first spatial path count in transmissions to the first receiving node.

2. The method as claimed in claim 1, wherein the first spatial path count is determined by iteratively evaluating a plurality of candidate first spatial path counts.

3. The method as claimed in claim 1, wherein the first spatial path count is determined as a solution to a multi-objective optimization problem.

4. The method as claimed in claim 1, wherein the transmitting node is caused to use the determined first spatial path count by adjusting a precoder of the transmitting node.

5. The method as claimed in claim 1, wherein the transmitting node is caused to use the determined first spatial path count by adjusting a count of active transceiver chains.

6. The method as claimed in claim 1, wherein the wireless telecommunications network includes a second receiving node, and the method further comprises:
determining that a second spatial path count for transmissions between the transmitting node and the second receiving node satisfies a second SINR threshold and a second capacity threshold; and
causing the transmitting node to use the determined second spatial path count in transmissions to the second receiving node.

7. A non-transitory computer-readable storage medium storing a computer program comprising instructions which, when the computer program is executed by a computer, cause the computer to carry out the method of claim 1.

8. A system comprising:
at least one processor and memory comprising instructions which, when executed, cause the at least one processor to carry out the method of claim 1.

9. A network node for a wireless telecommunications network, the wireless telecommunications network including a transmitting node and a first receiving node, the network node comprising:
a processor configured to:
determine that a first spatial path count for transmissions between the transmitting node and the first receiving node satisfies a first Signal to Interference plus Noise Ratio (SINR) threshold and a first capacity threshold, and
cause a transmitter of the transmitting node to use the determined first spatial path count in transmissions to the first receiving node.

10. The network node as claimed in claim 9, wherein the first spatial path count is determined by iteratively evaluating a plurality of candidate first spatial path counts.

11. The network node as claimed in claim 9, wherein the first spatial path count is determined as a solution to a multi-objective optimization problem.

12. The network node as claimed in claim 9, wherein the network node is the transmitting node.

13. The network node as claimed in claim 12, wherein the transmitting node uses the determined first spatial path count by adjusting a precoder of the transmitting node.

14. The network node as claimed in claim 12, wherein the transmitting node uses the determined first spatial path count by adjusting a count of active transceiver chains.

15. The network node as claimed in claim 9, wherein the wireless telecommunications network includes a second receiving node, and the processor is further configured to:
determine that a second spatial path count for transmissions between the transmitting node and the second receiving node satisfies a second SINR threshold and a second capacity threshold; and
cause the transmitter of the transmitting node to use the determined second spatial path count in transmissions to the second receiving node.
